(19) United States
(12) Patent Application Publication
(10) Pub. No.: US 2012/0292202 A1
(43) Pub. Date: Nov. 22, 2012

(54) COMPOSITION AND METHODS FOR ELECTROLYTIC SWIMMING POOL CHLORINATION SYSTEMS

(75) Inventors: Jessica Adkins, Kimball Township, MI (US); Martin N. Aschauer, Port Huron, MI (US)

(73) Assignee: Cargill, Incorporated, Wayzata, MN (US)

(21) Appl. No.: 13/475,473

(22) Filed: May 18, 2012

Related U.S. Application Data
(60) Provisional application No. 61/488,538, filed on May 20, 2011.

(51) Int. Cl. C02F 1/461

(52) U.S. Cl. 205/742

(57) ABSTRACT

The present disclosure relates generally to chloride salt compositions and methods for use in electrolytic pool chlorination systems comprising an water soluble chloride salt and an anti-caking additive that facilitates the rapid dissolution and dispersion of the salt in the pool without causing the detrimental effects to the water, pool, or chlorinator systems associated with other commonly used anti-caking agents.

### CROSS-REFERENCE TO RELATED APPLICATIONS

This application claims the benefit of U.S. Provisional patent application, Ser. No. 61/488,538, filed 20 May 2011, entitled COMPOSITION AND METHODS FOR ELECTROLYTIC SWIMMING POOL CHLORINATION SYSTEMS, which is hereby incorporated by reference in its entirety.

### FIELD

The present application generally relates to chloride salt compositions and methods used in swimming pools. Such compounds are added to swimming pools to control bacteria and other substances harmful to humans.

### BACKGROUND

Hypochlorite salts are commonly added to swimming pool systems to control the proliferation of substances harmful to humans such as bacteria. There are a number of ways hypochlorite can be added to pools and pool systems, such as by adding them manually or through a system, including the popular electrolytic chlorination systems, which generate hypochlorite automatically in situ. Adding hypochlorite manually is generally not preferred as the compositions are often concentrated and can be hazardous to humans in that form.

Electrolytic chlorination systems provide an efficient method to automatically chlorinate swimming pools and eliminate the need to handle hazardous chemicals such as the concentrated hypochlorite compounds. Common salt (sodium chloride) can be used with electrolytic chlorination systems for pools to make hypochlorite. Typically sodium chloride is dissolved in the pool water at a concentration of about 1800 to 6000 parts per million (ppm), and the water is circulated through a cell which converts the chloride into hypochlorite by electrolysis.

Although any type of salt can be used, high purity sodium chloride with a small particle size is preferable for electrolytic pool chlorination systems as the smaller particle size facilitates rapid dissolution of the salt in the water and distribution throughout the pool. However, this presents a challenge because high purity sodium chloride with a small crystal size is very susceptible to caking. Caking occurs when sodium chloride crystals alternately absorb and lose surface moisture during storage, leading to the growth of “crystal bridges” that tend to fuse the salt together into a hard, unflowable mass. Caked salt is a nuisance in swimming pool applications as it slows dissolution and generally inhibits rapid distribution of the salt throughout the pool body.

Caking of pool salts is a significant issue in swimming pool maintenance without a readily available solution. The common anti-caking agents used in sodium chloride compositions are not compatible with swimming pool applications. For example, sodium ferrocyanide is one of the most commonly used anti-caking agents for sodium chloride, but it is considered undesirable in pools because it tends to cause staining over time. Other water soluble anti-caking agents for sodium chloride have been identified, such as ferric ammonium citrate, metal complexes of mesotartaric acid, titanyl oxalate salts, nitrilotriacetamide, glycerine, and propylene glycol. These all have various disadvantages for pool applications such as the potential to cause staining, possible toxicity, poor effectiveness, and/or the tendency to support the very microbiological growth the pool salts are intended to control. Furthermore, water soluble anti-caking agents such as those listed above may accumulate in a pool with repeated salt addition as the standard pool filtration systems are designed to remove particles as small a five microns but are not designed to remove water soluble compounds.

There is therefore a need for anti-caking agents for chloride salt compositions that are specially suited to the specific needs of swimming pools, e.g., additives which are preferably natural, non-toxic, non-staining, will not contribute to microbiological growth, and which are compatible with pool filtration systems and electrolytic cells.

### SUMMARY

The present disclosure relates to a chloride salt composition for use with an electrolytic swimming pool chlorination system that comprises an alkali metal chloride salt and an anti-caking additive such as silicon dioxide, which inhibits caking of the salt without causing detrimental effects to the water, pool, or chlorinator system. The water soluble chloride salt can be sodium chloride, potassium chloride, or combinations thereof. Other water soluble chloride salts are calcium chloride, magnesium chloride, ammonium chloride, lithium chloride, or combinations thereof. The water soluble chloride has a particle size range of between 50 and 4,000 microns. In one embodiment, the water soluble chloride salt is sodium chloride. In another embodiment, the anti-caking additive is selected from silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

One embodiment is directed toward a chloride salt composition for use with electrolytic pool chlorination systems comprising a water soluble chloride salt and an anti-caking additive where the anti-caking additive is silicon dioxide. The composition provides improved caking resistance and compatibility with electrolytic swimming pool chlorination systems.

The anti-caking additive of the chloride salt composition can have a particle size range of between 0.005 and 500 microns. Suitable sources of an anti-caking additive can include silicon dioxide, sand, diatomaceous earth, ground silica, synthetic amorphous silica, precipitated silica, fumed silica, or combinations thereof.

Another embodiment of the present invention presents a process for using a chloride salt composition in an electrolytic swimming pool chlorination system by providing a water soluble chloride salt, where the chloride salt has a particle range of between 50 and 4,000 microns, providing an anti-caking agent, where the additive has an average particle size of between about 0.005 microns and 500 microns, and combining the water soluble chloride salt and the anti-caking agent to yield a chloride salt composition for addition to the electrolytic swimming pool chlorination system. In one embodiment, the water soluble chloride salt is sodium chloride, potassium chloride, calcium chloride, magnesium chloride, ammonium chloride, lithium chloride, or combinations thereof, and where the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

### DETAILED DESCRIPTION

### Chloride Salt Composition

The chloride salt composition of the present invention comprises a mixture of a water soluble chloride salt where the chloride salt has a particle range of between 50 microns and 4,000 microns, and an anti-caking additive where the anti-caking additive is silicon dioxide for use in an electrolytic swimming pool chlorination system. In one embodiment, the water soluble chloride salt can be selected from sodium chloride, potassium chloride, or combinations thereof. In one embodiment, the water soluble chloride salt is sodium chloride. In another embodiment, the anti-caking additive is sand, diatomaceous earth, ground silica, synthetic amorphous silica, precipitated silica, fumed silica, or combinations thereof. Other anti-caking agents include tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

In one embodiment a chloride salt composition for use in an electrolytic swimming pool chlorination system comprises a water soluble chloride salt and an anti-caking additive where the concentration of the anti-caking agent is between 0.1% and 5.0% by weight of the composition and the alkali metal chloride is between 95.0% and 99.9% by weight of the composition. In another embodiment, the concentration of the anti-caking agent is between 0.5% and 1.5% by weight of the composition and the alkali metal chloride is between 98.5% and 99.5% by weight of the mixture. In another embodiment, the concentration of the anti-caking agent is between 0.1% and 1.0% by weight of the composition and the alkali metal chloride is between 99.0% and 99.9% by weight of the mixture. In one embodiment, the anti-caking agent is silicon dioxide. In one embodiment, the water soluble chloride salt can be sodium chloride, potassium chloride, or combinations thereof. In another embodiment, the anti-caking additive is sand, diatomaceous earth, ground silica, synthetic amorphous silica, precipitated silica, fumed silica, or combinations thereof. In one embodiment the alkali chloride salt composition is added to pool water for use with electrolytic chlorination systems.

### Water Soluble Chloride Salt

The water soluble chloride salt of the composition is a chloride salt of, for example, sodium or potassium which supplies a source of water soluble chloride to pool water for subsequent oxidation to hypochlorite by an electrolytic chlorination system. In one embodiment the water soluble chloride salt is sodium chloride. Potassium chloride or mixtures of sodium chloride and potassium chloride can also be used. Other alkali metal salts can be calcium chloride, magnesium chloride, ammonium chloride, lithium chloride, or mixtures thereof. In one embodiment the water soluble chloride salt has a particle size range between 50 and 4,000 microns. In another embodiment, the water soluble chloride salt has a particle size range between 50 and 600 microns. In yet another embodiment, the water soluble chloride salt has a particle size range between 50 and 200 microns.

Anti-Caking Agent The anti-caking agent of the composition is silicon dioxide with an average particle size of between 0.005 to 500 microns. In another embodiment the particle size of the anti-caking agent is between 0.1 microns to 30 microns. In yet another embodiment the particle size of the anti-caking agent is between 1 micron and 10 microns. In one embodiment, the anti-caking additive is an amorphous precipitated silica with an average particle size less than 10 microns. Suitable sources include silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

### Method of Using A Chloride Salt Composition

The present invention presents a process for using a chloride salt composition in an electrolytic swimming pool chlorination system by providing a water soluble chloride salt, where the chloride salt has a particle range of between 50 and 4,000microns and by providing an anti-caking agent, wherein the additive has an average particle size of between about 0.005 microns and 500 microns, and by combining the water soluble chloride salt and the anti-caking agent to yield a chloride salt composition for addition to the electrolytic swimming pool chlorination system. In one embodiment, the water soluble chloride salt is sodium chloride, potassium chloride, calcium chloride, magnesium chloride, ammonium chloride, lithium chloride, or combinations thereof, and where the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

In another embodiment, the concentration of the anti-caking agent is between 0.5% and 1.5% by weight of the composition and the alkali metal chloride is between 98.5% and 99.5% by weight of the mixture. In another embodiment, the concentration of the anti-caking agent is between 0.1% and 1.0% by weight of the composition and the alkali metal chloride is between 99.0% and 99.9% by weight of the mixture. In one embodiment, the anti-caking agent is silicon dioxide. The anti-caking agent of the composition is silicon dioxide with an average particle size of between 0.005 to 500 microns. In another embodiment the particle size of the anti-caking agent is between 0.1 microns to 30 microns. In yet another embodiment the particle size of the anti-caking agent is between 1 micron and 10 microns. In one embodiment, the anti-caking additive is an amorphous precipitated silica with an average particle size less than 10 microns.

In another embodiment, the present invention involves a process for using a chloride salt composition in an electrolytic swimming pool chlorination system by providing an water soluble chloride salt, where the chloride salt has a particle range of between 50 and 4,000 microns and by providing an anti-caking agent, wherein the additive has an average particle size of between about 0.005 microns and 500 microns, combining the water soluble chloride salt and the anti-caking agent to yield a chloride salt composition, and utilizing the chloride salt composition in an electrolytic swimming pool chlorination system. In one embodiment, the water soluble chloride salt is sodium chloride, potassium chloride, calcium chloride, magnesium chloride, ammonium chloride, lithium chloride, or combinations thereof, and where the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

In another embodiment, the concentration of the anti-caking agent is between 0.5% and 1.5% by weight of the composition and the alkali metal chloride is between 98.5% and 99.5% by weight of the mixture. In another embodiment, the concentration of the anti-caking agent is between 0.1% and 1.0% by weight of the composition and the alkali metal chloride is between 99.0% and 99.9% by weight of the mixture. In one embodiment, the anti-caking agent is silicon dioxide. The anti-caking agent of the composition is silicon dioxide with an average particle size of between 0.005 to 500 microns. In another embodiment the particle size of the anti-caking agent is between 0.1 microns to 30 microns. In yet another embodiment the particle size of the anti-caking agent is between 1 micron and 10 microns. In one embodiment, the anti-caking additive is an amorphous precipitated silica with an average particle size less than 10 microns.

In yet another embodiment, the present invention involves a process for using a chloride salt composition in an electrolytic swimming pool chlorination system by providing a water soluble chloride salt composition for addition to the electrolytic swimming pool chlorination system. where the chloride salt composition comprises an water soluble chloride salt wherein the chloride salt has a particle range of between 50 and 4,000 microns; an anti-caking agent, wherein the additive has an average particle size of between about 0.005 microns and 500 microns; and utilizing the chloride salt composition in an electrolytic swimming pool chlorination system. in one embodiment, the water soluble chloride salt is sodium chloride, potassium chloride, calcium chloride, magnesium chloride, ammonium chloride, lithium chloride, or combinations thereof, and where the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

In another embodiment, the concentration of the anti-caking agent is between 0.5% and 1.5% by weight of the composition and the alkali metal chloride is between 98.5% and 99.5% by weight of the mixture. In another embodiment, the concentration of the anti-caking agent is between 0.1% and 1.0% by weight of the composition and the alkali metal chloride is between 99.0% and 99.9% by weight of the mixture. In one embodiment, the anti-caking agent is silicon dioxide. The anti-caking agent of the composition is silicon dioxide with an average particle size of between 0.005 to 500 microns. In another embodiment the particle size of the anti-caking agent is between 0.1 microns to 30 microns. In yet another embodiment the particle size of the anti-caking agent is between 1 micron and 10 microns. In one embodiment, the anti-caking additive is an amorphous precipitated silica with an average particle size less than 10 microns.

The anti-caking agent and methods of the present invention have particularly unique advantages. It is an environmentally-friendly, natural, non-toxic substance that will not stain pools nor contribute to microbiological growth. Moreover, it is very compatible with pool filtrations systems that are able to filtrate out the silicon dioxide as well as the electrolytic cells.

### Examples

Aspects of certain methods in accordance with aspects of the invention are illustrated in the following examples. In addition, tests have been developed to measure the effectiveness of this disclosure.

### Example 1

Caking tests are run according to the following procedure: Triplicate 300 gram samples of sodium chloride are sealed in small, porous bags and stored under a pressure of 4.3 pounds per square inch and a temperature of 75° F/24° C. in an environmental chamber. Untreated samples containing no anti-caking agent are used as controls. Treated samples are prepared by blending 0.5% of an amorphous precipitated silica having an average particle size of 2.5-3.7 microns) with sodium chloride. The sodium chloride is a high purity evaporated salt (minimum 99.8% NaCl) of either “granulated” (about 210-590 micron) or “flour” (about 50-210 micron) particle size ranges. The samples are exposed to 80% relative humidity for three days followed by 40% relative humidity for four days at room temperature. The samples are then removed from the environmental chamber and shaken on a Ro-Tap sieve shaker for 5 seconds. Any remaining caked material is separated and weighed to determine the percent caked material.

TABLE 1
Effectiveness of Silica Anti-Caking Agent

| Salt Type | Treatment | Average % Caked |
|---|---|---|
| Granulated | None (control) | 65.6 |
| Granulated | 0.5% silica | 7.5 |
| Flour | None (control) | 74.3 |
| Flour | 0.5% silica | 27.2 |

The data in Table 1 shows that addition of 0.5% amorphous precipitated silica to the chloride salt to form a chloride salt composition results in an 89% reduction in the degree of caking in “granulated” salt as compared to a regular granulated salt. Similarly, a 65% reduction in caking is seen by the use of the chloride salt composition using the finer gradation “flour” salt as compared to the regular flour salt without the addition of the anti-caking agent.

The particular embodiments disclosed above are illustrative only, as the present disclosure can be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above can be altered or modified and all such variations are considered within the scope and spirit of the present disclosure. Accordingly, the protection sought herein is as set forth in the claims below.

We claim:

1. A chloride salt composition for use in electrolytic swimming pool chlorination systems comprising:
a. a water soluble chloride salt, wherein the chloride salt has a particle range of between 50 and 4,000 microns; and
b. an anti-caking additive, wherein the additive has an average particle size of between about 0.005 microns and 500 microns.

2. The composition of claim 1, wherein the water soluble chloride salt comprises sodium chloride, potassium chloride, calcium chloride, magnesium chloride, ammonium chloride, lithium chloride, or combinations thereof.

3. The composition of claim 1, wherein the water soluble chloride salt has a particle range of between 50 and 600 microns.

4. The composition of claim 2 wherein the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

5. The composition of claim 2, wherein the anti-caking additive is silicon dioxide with an average particle size of between about 0.1 microns and 30 microns.

6. The composition of claim 2, wherein the anti-caking additive is a silicon dioxide with an average particle size of between 1 micron and 10 microns.

7. A chloride salt composition for use in an electrolytic swimming pool chlorination system comprising:
a. a water soluble chloride salt; and
b. an anti-caking additive, wherein the additive is silicon dioxide, and wherein the concentration of the anti-caking agent is between 0.1% and 5.0% by weight of the composition and the alkali metal chloride is between 95.0% and 99.9% by weight of the composition.

8. The composition of claim 7 wherein the concentration of the anti-caking agent is between 0.5% and 1.5% by weight of the composition and the alkali metal chloride is between 98.5% and 99.5% by weight of the composition.

9. The composition of claim 7 wherein the water soluble chloride salt comprises sodium chloride, potassium chloride, or combinations thereof.

10. The composition of claim 7 wherein the anti-caking additive is selected from sand, diatomaceous earth, ground silica, synthetic amorphous silica, precipitated silica, fumed silica, or combinations thereof.

11. A method for using a chloride salt composition in an electrolytic swimming pool chlorination system comprising:
a. providing a water soluble chloride salt, wherein the chloride salt has a particle range of between 50 and 4,000microns;
b. providing an anti-caking agent, wherein the additive has an average particle size of between about 0.005 microns and 500 microns; and
c. combining the water soluble chloride salt and the anti-caking agent to yield a chloride salt composition for addition to the electrolytic swimming pool chlorination system.

12. The method of claim 11, wherein the water soluble chloride salt comprises sodium chloride, potassium chloride, calcium chloride, magnesium chloride, ammonium chloride, lithium chloride, or combinations thereof, and wherein the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, tale, potassium aluminum silicate or sodium aluminum silicate, calcium aluminosilicate, bentonite, aluminum silicate, alumina, calcium carbonate, magnesium carbonate, kaolin or combinations thereof.

13. A method for using a water soluble chloride salt composition in an electrolytic swimming pool chlorination system comprising:
a. providing a water soluble chloride salt, wherein the chloride salt has a particle range of between 50 and 4,000microns;
b. providing an anti-caking agent, wherein the additive has an average particle size of between about 0.005 microns and 500 microns;
c. combining the water soluble chloride salt and the anti-caking agent to yield a water soluble chloride salt composition; and
d. utilizing the chloride salt composition in an electrolytic swimming pool chlorination system.

14. The method of claim 13, wherein the water soluble chloride salt comprises sodium chloride, potassium chloride, calcium chloride, magnesium chloride, ammonium chloride, lithium chloride, or combinations thereof, and wherein the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.

15. A method for using a chloride salt composition in an electrolytic swimming pool chlorination system comprising:
a. providing a water soluble chloride salt composition for addition to the electrolytic swimming pool chlorination system. wherein the chloride salt composition comprises an akali metal chloride salt wherein the chloride salt has a particle range of between 50 and 4,000 microns; an anti-caking agent, wherein the additive has an average particle size of between about 0.005 microns and 500 microns; and
b. utilizing the chloride salt composition in an electrolytic swimming pool chlorination system.

16. The method of claim 15, wherein the water soluble chloride salt comprises sodium chloride, potassium chloride, calcium chloride, magnesium chloride, ammonium chloride, lithium chloride, or combinations thereof, and wherein the anti-caking additive comprises silicon dioxide, sand, diatomaceous earth, ground silica, synthetic amorphous silica, precipitated silica, fumed silica, tricalcium phosphate, sodium silicoaluminate, bone phosphate, calcium silicate, magnesium silicate, magnesium trisilicate, talc, potassium aluminum silicate or sodium aluminum silicate, calcium aluminosilicate, bentonite, aluminum silicate, alumina, calcium carbonate, magnesium carbonate, kaolin or combinations thereof.
